(19) United States
(12) Patent Application Publication
(10) Pub. No.: US 2012/0215708 A1
(43) Pub. Date: Aug. 23, 2012

(54) SOCIAL COMMUNITY REVOLVING AROUND NEW MUSIC

(76) Inventor: Jon POLK, Los Angeles, CA (US)

(21) Appl. No.: 13/398,347

(22) Filed: Feb. 16, 2012

Related U.S. Application Data
(60) Provisional application No. 61/443,956, filed on Feb. 17, 2011.

(51) Int. Cl. G06Q 99/00

(52) U.S. Cl. 705/319

(57) ABSTRACT

An online social community uses lists maintained by each community member, with corresponding community consensus charts reflecting the tabulation of the individual member charts weighted to reflect each member's status and rating as a tastemaker, influencer or follower. The status and ratings will be calculated to reflect (a) the individual member's history and timeliness in identifying and/or following artists or music within the community results; and (b) the individual member's history and value of influencing other members of the community to adopt their choices.

### REFERENCE TO RELATED APPLICATION

The present application claims the benefit of U.S. Provisional Patent Application No. 61/443,956, filed Feb. 17, 2011, whose disclosure is hereby incorporated by reference in its entirety into the present disclosure.

### FIELD OF THE INVENTION

The present invention is directed to a social community revolving around the discovery, debate and discussion of new music, which will evolve into a sophisticated and reliable filter for discovering music by the general public, and in turn become a market research, marketing and advertising platform which can be leveraged and monetized.

### DESCRIPTION OF RELATED ART

Historically, new music has been discovered, and awareness and appreciation has spread and grown, through early tastemakers who initially “discover” it, and then through early influencers who adapt first to the discoveries and influence of these tastemakers and begin to more broadly spread awareness to later influencers and followers, until the music reaches broad consensus adoption by and throughout a particular community. Subsequently, on a larger scale, the music could spread from community to community. In essence, new discoveries were able to develop and reach consensus awareness and adoption first through small communities, where they were “nurtured” through the natural processes of human community interaction; then, after reaching popularity within their own communities (i.e., after being filtered through the interaction of their own community) they were able to spread to other communities.

Prior to the advent and broad adoption of digital technologies, most of this process was obstructed by systematic friction (whether through financial barriers, communication barriers, distribution barriers, geographical barriers and/or other barriers of access) which acted as the filters of new music that reached (and controlled when they reached) the tastemakers and influencers; and enabled or disabled the broader communication and access to that filtered information. In the later part of the last century, that systematic friction consisted of a limited universe of major record companies, powerful radio stations, MTV, major retailers and popular news sources.

The advent of broadly available and adopted digital technologies has broken down most of the barriers of access to the creation of new music and other art forms; now allows almost unfettered, simultaneous flow and availability of information (i.e., those art forms) to virtually all users of technology (i.e., virtually everyone), regardless of geographical location; and has virtually eradicated most of other barriers that historically filtered what information most people became aware of or have access to and when.

While this has created the exciting prospect of a so-called “even playing-field” for the creators of new music and other art forms, and the promise of unobstructed, frictionless access to a music lover's nirvana, it has also given birth to new obstructive frictions. Namely, all of the simultaneously available new information has created an almost infinitely larger, unfiltered pool of information which creates newer, formidable barriers for any particular new music and/or new artists to navigate and/or scale to build and reach broad consensus appreciation.

Also, while certainly there are still smaller communities both online and offline where the natural, human process of discovery and influence still functions, the new broad, immediate availability of most new music without geographic barrier, and the unfiltered even playing-field, creates almost infinite competition within and across communities, which tends to create community silos with limited reach and influence. Moreover, no one has been able to harness the access and power provided by these new digital technologies to create a reliable filter for scaling these new barriers, and at the same time taking advantage of the great promise of access to the universe of new music now available; or to use the millions and millions of tastemakers, influencers and followers online to create consensus across communities on a scale that the new inter-connected world promises.

While many online vendors such as Amazon, Netflix and Apple's iTunes use various algorithms to generate recommendations based on automated filtering of data, these recommendations are essentially based on a one-man/one-vote method of tabulation, treating each purchase as an equal vote by consumers, with results that are not filtered but instead simply reflect the lack of filtering of the information that reaches most consumers.

While there are many outlets on-line where friends can share their new music discoveries, such as through Facebook and Spotify and through iTunes Ping, as examples, these generally limit a user to information provided by their friends, and friends of friends, who they may or may not trust as good tastemakers or influencers of their own tastes; they rarely know the source of information for these recommendations and do not have the tools or context to evaluate any individual's value as a trusted tastemaker or influencer; and, ultimately, there is no systematic way of filtering through and finding trusted tastemakers and influencers, whether they are friends or not.

Other so-called online and off-line “tastemakers” or “curators of taste” exist, such as RollingStone.com or Pitchfork.com, as a resource for the average person to access for new music recommendations. Moreover, many people look to celebrities and so-called “experts” on Twitter and various online and offline resources that provide access to curated “playlists” and recommendations. However, no single tastemaker or curator is able on its own to effectively listen to and filter through all of the new music that is now available.

### SUMMARY OF THE INVENTION

There is thus a need for an algorithm and system of social tools that can harness the access and recommendations of the hundreds of millions of people who are online and who each individually have access to all of the music that is available; that can filter all of the recommendations of all of those people in a trusted way that can create a hierarchy of recommendations weighted by the credibility of each individual, across a nuanced spectrum, as tastemakers, influencers and followers; and that allow consensus appreciation for new music to develop in a manner that replicates the way new music spreads and develops to consensus appreciation in the most frictionless way possible.

It is thus an object of the invention to provide an algorithm and a system of social tools to collect and feed data into that algorithm, to do just that.

To achieve the above and other objects, the unique aspects of the social community are that:

(1) it revolves around a focused context for the discussion and debate, in a social and competitive way, as opposed to a forum for random opinions and comment; and

(2) it will be built to replicate the way in which new music is discovered and shared and gains broad acceptance in the real world; so, opinions and information, and ultimately the results of the community debates and actions will be weighted to reflect the status of the community members as tastemakers, influencers and/or followers (as opposed to the one man/one vote value generally given to opinions across the Internet).

The net result will be a statistically reliable music filter that can be leveraged and monetized. It will offer music picks, opinions and recommendations to the broader general public, filling a void in the current marketplace that was created by the fracturing of the infrastructure for filtering, marketing and promoting music, brought on by advances in technology; become a platform to test, market and launch new music; and be able to finely define and identify consumers specifically by their interests and tastes. The present invention can thus be used to implement a crowd-source music filter or crowd-sourced curation and to empower the individual to participate in identifying and spreading awareness and appreciation of new music that they champion.

The invention provides an online community where members are encouraged to introduce the community to new music (whether by new artists or not) and new artists; to influence and encourage other members to join the “bandwagon” touting that music/artist; and to raise awareness and appreciation of the music/artist across the community.

It will replicate the way in which music is discovered and championed and achieves mass appreciation in the real world: tastemakers identifying/championing certain music, then influencing different levels of followers to join the bandwagon until it picks up the broad following that supports and provides mass acceptance/appreciation.

The core application of the community will be lists (likely, music “playlists”) maintained by each community member, with corresponding community consensus charts reflecting the tabulation of the individual member charts weighted to reflect each member's status and rating as a tastemaker, influencer or follower. The status and ratings will be calculated to reflect (a) the individual member's history and timeliness in identifying and/or following artists or music within the community results, (b) the individual member's history and value of influencing other members of the community to adopt their choices, (c) the rate of consensus adoption by the community of an individual's choices, and (d) the status and rating value of those directly influenced in the chain of influence by that individual.

Members will be encouraged, and will be offered the forums, to debate and influence others about new artists and new music (whether by new or existing, even classic artists), fueled by the competition for prizes as well as status within the community. Their status in the community and ability to be rewarded will be affected by how their choices are adopted by the community at large and how instrumental they are in influencing other community members to adopt their recommendations.

The lists/charts are rankings of “favorite/best” music in various categories. Examples include the “best new recordings of 2012,” “best new albums of 2012,” “best female artists of 2012,” and “best new artists of 2012.” Also, to add dimension to the status and rating tabulations, and to make it easier and more accurate for others to identify members with whom they believe they have common tastes and opinions, or whose opinion they trust as an influencer (and to stimulate interest and participation), lists like the following can be used: “best rock band of the last 10 years,” “best singer songwriter of the last 30 years.”

Some categories will be created by the webmaster of the community; others can be created by any community member (subject to approval of the community webmaster). Each list will have a limited number of spots (10-20 for most) although the corresponding consensus chart will be two to ten times larger.

Each list/chart is an individual “contest” for credibility as well as for prizes and other awards. Each list/chart contest will run for a set, measuring time period. This can be different for each list/chart—e.g., “best new music of 2012” should run based on a calendar basis, calendar quarter or calendar year, during 2012; whereas others can be tied to more flexible dates, so that lists such as “best guitarist of the last 50 years” and “best love songs of all time” can have any arbitrary run dates.

Winners are determined within each chart contest, based on whose list represents the greatest consensus match across the community when the lists in that category “close” at the end of the measuring period—who has the most artists on their list who appear the most times on other member's lists in that category—weighted by when and how long each of those (greatest consensus) artists appeared on that member's list; with bonus weighting in favor of the member who initially added/introduced each such specific artist or music onto the list and/or into the community (a “tastemaker”); and a weighting in favor of those tastemakers, and early followers of those tastemakers, whose entries rise to consensus status in the community at a slower rate of adoption and/or over a longer period of time. So, early tastemakers, who create the “bandwagon” for the artist who rises to consensus popularity on the list and in the community, gain the most points relative to how long that artist remains on their chart; followed next by the members who followed in joining that bandwagon earliest, possibly with a negative adjustment for early tastemakers who ultimately remove entries they initially introduced onto a chart.

In addition, once an artist or piece of music (a song, recording, or album) is introduced into the community, any other community member (a “follower,” in this context) who wants to add that artist or piece of music to one of their lists must do so by designating an “influencer” member (a community member who already has that piece on one of their lists). They will be offered choices of the highest ranking members who have already placed that artist/music on that specific list, and/or members whose overall choices correlate closest to theirs and who have already placed that artist/music on that specific list (although they can instead choose to “follow” by selecting from any other members list which includes that artist/music). Those designations will add to the status/credibility ratings of the designated influencers. The followers will be incentivized to pick the person they most value as an influencer, as their selection off a specific influencer's list will thereafter give them notifications of future choices made by the influencer on his/her own lists and/may also effect the weighting in determining their own rating and status.

Each game/list begins and ends with a short Black Box period where entries on playlists are tabulated, but members cannot view the consensus charts until after the Black Box period. The beginning BlackBox period enables any member to add an entry to that game/list without designating an influencer, and the member will automatically be designated as a tastemaker for their entries during the Black Box period. Only the first/earliest tastemaker to add a particular entry will be deemed to be the “crowned” tastemaker for that entry, and their entry, and the chain of influence that flows from their entry, will have the potential to carry the greatest weighting for that entry. The ending Black Box period allows members to add entries to their lists up until the moment that a particular game ends, without complete certainty regarding whether any entry will end up a consensus entry, or a particularly high ranking consensus entry.

Thus, members are encouraged to introduce new music/artists to the community; to be early adopters of new music/artists; and to tout that music/artists' worthiness to the community and create a greater consensus around that music/artist, to earn credibility/status, prizes and other rewards.

To encourage other members to sample and ultimately adopt artists and music that a member recommends, there will be various mechanisms to tout those artists/music to the community.

Each time an artist is added to a list by a member, that member can include a few lines of explanation (viewable by a rollover link) to encourage others to follow their recommendations. The aggregate of such member comments on a specific recording and/or artist will comprise the core of the “bandwagon” page for that recording/artist.

Each member will have a blog on their own home/community page (where their own lists are maintained), where they can tout the artists on their lists.

There will also be community discussion forums where members can debate and discuss the artists, the music and their charts.

Each artist (and corresponding music) “introduced into” the community should have a community “artist page,” which in its simplest from can be simple links to the artist's Myspace, Bandcamp or other similar pages; and links to discussion forums and blogs within the community relating to that artist (a constantly updated list of the latest discussions across the community about that artist). A person first introducing the artist into the community can create the first page for that artist. Eventually, sections of these pages can be controlled by the artists and/or their record companies or representatives (to feature and share information, and possibly even sell music and merchandise.)

In addition, there will be prominent “soap boxes” within the community: main pages where the members with the highest credibility/status rankings in certain categories (i.e., the reigning leaders on the charts) will have the space to blog about their views in a prominent way. Those soap box blogs will be prominently displayed in the blog/discussion sections on the artist page of the artist being discussed. And as “headline information” on all individual community member home pages.

And there will be a daily blog and email sent to members, which may help shape the focus and discussion within the community, highlight trends and new discoveries by high rated members, include input and analysis by experts and celebrities, and highlight soap box blogs by members with the highest credibility/status rankings.

Finally each member, on their own home page, will be able to follow discussions within the community:

(1) regarding artists they choose to follow (including outside news and updated information about their favorite artists, culled from a number of potential sources, but ultimately from the artists or their representatives themselves, artists websites and Twitter feeds, for example);

(2) by other members they designate (think similar to the “like” function on facebook);

(3) regarding particular charts they choose to follow.

This is an application that can help reinforce that members return regularly to check up on up to date information on their favorite artists.

Members can be encouraged to participate through various means of reward:

(1) status in the community, including qualifying for soap box touting, and a system of badges based on level of tastemaker credibility.

(2) prizes for contests based on particular lists over defined time periods (can be financial, and/or can be prize packages and “experiences” supplied by sponsors; and

(3) if the site is linked with a music/merchandise store (even as a rewarded referral), perhaps the member who initially introduces an artist or particular music to the community can earn referral fees/rewards for all purchases by community members; perhaps a similar reward structure based on advertisements clicked through on members pages.

A member could:

earn points (and a “Credibility” rating) as a tastemaker/champion;

rise up the ranks of the champions;

earn points redeemable for prizes and gain status in the community (sit on the online throne for as long that member is king—earn levels of status that can attach to that person's avatar widget which can be viewed/accessed on that person's own website/Facebook/Myspace page;

earn money on any music or merchandise bought by clicking through a buy button on that person's community page; and

earn money on sales of music and merchandise by any artist that that person introduces and champions in the community—when bought by anyone through the site, whether through the link on that person's page or not.

Aspects of the invention in at least some embodiments thus include the following, with optional features in brackets:

A [an online] game that measures player activity and actions to create a crowd sourced [music] filter.

A [music] filter that measures input of established tastemakers and early influencers over later followers.

A [music] filter that measures input of established tastemakers, and early influencers over later followers; and measures the level of influence a particular player has on other players.

A [music] filter that measures the input of established tastemakers, influencers and followers, along a hierarchy that weighs the input of tastemakers above follower influencers above later followers.

A [music] filter that measures the input of established tastemakers, influencers and followers, along a hierarchy that weighs the input of tastemakers above follower influencers above later followers, and weighs the input of particular players who have more influence over other players' selections more favorably than players who have less of such an influence.

A [music] filter that measures the input of established tastemakers, influencers and followers, along a hierarchy that weighs the input of tastemakers above follower influencers above later followers, in the form of a [an online] game.

A game that measures player activity and actions to filter music to weigh the actions and opinions of tastemakers and early influencers heavier than later followers.

A game that measures when players identify and/or adopt selections, vis-à-vis other players (and/or the outside world) to determine the players' status and/or credibility, vis-à-vis each other, as a tastemaker, influencer and/or follower, to filter (music).

A game that measures when players identify and/or adopt selections, vis-à-vis other players (and/or the outside world) to determine the players' status and/or credibility, vis-à-vis each other, as a tastemaker, influencer and/or follower, to filter (music).

A game that measures when players identify and/or adopt selections, vis-à-vis other players (and/or the outside world) to determine the players' status and/or credibility, vis-à-vis each other, in arriving at consensus agreement, as a tastemaker, influencer and/or follower, to filter (music).

A game that measures when players identify and/or adopt selections, vis-à-vis other players (and/or the outside world) to determine the players' status and/or credibility, vis-à-vis each other, in arriving at consensus agreement, where the longer the time that it takes a selection to reach consensus adoption, is weighed more favorably in the filtering [of music].

A game that requires followers to identify a specific influencer of their selection.

A game that creates chains of influence based on directly identified influencers on each player's selections to quantify each specific player's influence in the arrival of a consensus result.

A game that creates chains of influence based on directly identified influencers on each player's selections to quantify each specific player's influence in the arrival of a consensus result, and weighs the direct line of influence over higher rated and/or more influential players more highly.

### BRIEF DESCRIPTION OF THE DRAWINGS

A preferred embodiment of the present invention will be set forth in detail with reference to the drawings, in which:

FIG. 1 is a block diagram showing a system on which the preferred embodiment can be implemented; and

FIG. 2 is a diagram showing the interrelation of tastemakers, influencers, and followers.

### DETAILED DESCRIPTION OF THE PREFERRED EMBODIMENT

A preferred embodiment will be set forth in detail with reference to the drawings, in which like reference numerals refer to like elements or steps throughout.

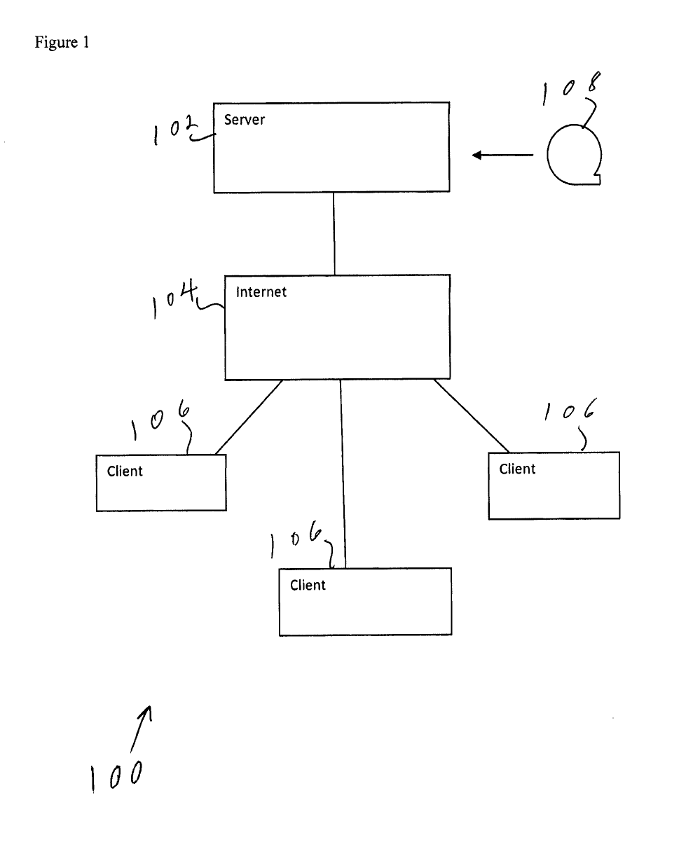

FIG. 1 is a block diagram of exemplary hardware 100 on which the present invention can be implemented, although any other suitable hardware can be used in addition to or instead of that shown. A server 102 running a suitable server operating system and suitable Web server software communicates over the Internet 104 with client devices 106 such as personal computers, tablet computers, and smartphones. The software to implement the online community can be supplied in any suitable manner, e.g., by persistent storage 108 such as a tape, DVD-ROM, hard drive, or solid-state device, and within an “app.” The clients, as noted above, can run standard Web browsers or specially written applications, e.g., smartphone “apps.”

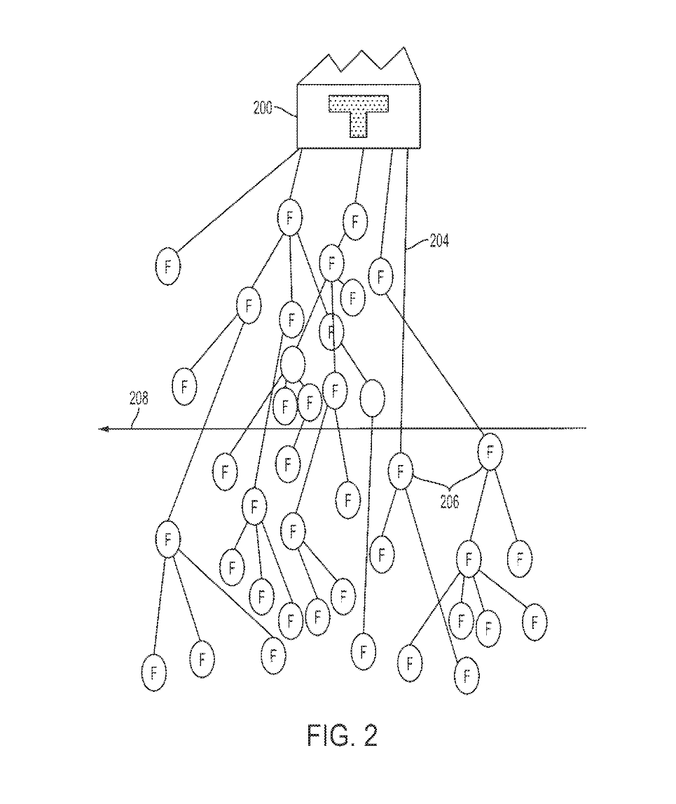

FIG. 2 is a schematic diagram showing the relationship among the tastemaker and multiple followers. In the preferred embodiment, a diagram such as that of FIG. 2 is not displayed to the users; rather, it is presented here to illustrate the internal calculations performed in the preferred embodiment. There is only one “crowned” tastemaker 202 for any entry, namely, the first player to list a particular entry on a particular list. There may be other tastemakers for a particular entry if they add the same entry during the “black box” period, but after the crowned tastemaker. Each tastemaker will similarly have chains of influence 204 following from their entry, but in stepped-down value relative to that of the crowned tastemaker and other preceding tastemakers.

Others that join the chain 204 are followers 206, although each follower is an influencer in the chain of influence (if any) that follows from that person. Each follower/influencer can have many chains of influence.

A dividing line 208 is drawn between early followers/influencers and later followers/influencers. That dividing line may be arbitrarily set to any point in time desired by the operator of the service. The later a link joins the chain, the less weight it carries for itself and those who follow it, but the more value it has for tastemakers and early influencers above the chain. That is, tastemakers and early influencers are weighted by the staying power of their influence, not just the number of others whom they influence. In particular, while one aspect of timing is that it is good to be early in identifying something, there is another aspect where it is good to be later: Under the algorithm, a tastemaker's and early influencer's influence is more highly valued if their entries take longer to reach consensus appreciation, to demonstrate that the influence is tied more to their influence in the game itself as opposed to the influence of outside factors. So, for example, being the first one to identify new music by Adele or Lady Gaga, now, would have less value than identifying an unknown artist who over time reaches consensus adoption.

The preferred embodiment implements a social game of “filtered” music discovery, using playlists. In an illustrative example, players compete in three playlist games: Best Recording Artist 2012, Best New Album 2012, and Best New Artist 2012.

Each player compiles up to 3 separate corresponding personal playlists: up to 10 recordings representing their picks for each game. For each playlist entry the player must include an artist name and a specific recording by that artist.

Concurrently, consensus charts (between 50 and 100 songs) for all three games are tabulated in real time based on the playlists of the community of players. Players are competing to most closely predict/match the ultimate consensus playlists at the end of 2012, but their results are measured in a point system that values each player's input based on whether that player is a tastemaker (most valued), influencer (next valued) or follower (less valued).

There is a broad spectrum of influencer and followers, ranging from early to late.

There may be more than one Tastemaker per entry (see below regarding Black Box and Red Box periods) but only a single (most highly valued) “crowned” tastemaker per entry in any particular game.

The exact order of a player's personal playlist is not relevant to his results—as long as one of the entries on one of his personal playlists appears on a consensus chart, he accumulates status points. The higher his entry appears on the consensus chart, however, the greater value it will have to him.

Players are free to change their playlist artists/music at any time during the play period. However, each player's actions will be mathematically evaluated based on:
WHEN: when the player adds a consensus artist (and a particular recording) to his personal playlists (the earliest to identify a consensus artist, as tastemaker, or, next, to add a consensus artist, as an early follower, are most valued); the longer it takes an artist to become a consensus artist, after that player adds the artist, whether as a tastemaker or early follower, is more valued (so adding a new Lady Gaga album, followed by quick consensus support, is less valued than adding an unknown artist who builds a consensus over time).
HOW LONG: how long the player consistently maintains that artist on his personal playlists (to avoid manipulation of results and to establish a commitment to a choice)
HOW INFLUENTIAL: who (by rating/ranking) and how many other players followed the player's influence in making a decision to add a particular consensus artist (being early in the chain of influence is valued higher, as is having higher rated players directly follow you in the chain of influence).

These evaluations will in turn be used to weigh the tabulation of the consensus playlists, earn the individual player status and eligibility for badges and other rewards, and establish the credibility of the player within the social features of the App/community. (Status and credibility levels will attach to a player across the different playlist games, as well as in future playlist games).

Using social features of the App, players will be able to debate and try to convince other players to adopt their playlist choices (and in turn increase their own status as a Tastemaker and/or Influencer, and their overall scores). Social features of the App will allow players to:
Individually or collectively create an interactive “Bandwagon” page to advocate, raise awareness and broaden appreciation for specific artists);
Identify other players whose opinions correlate with theirs (“relevancy”), and access those players' playlists and social interactions (i.e., recommendations and advocacy);
Reliably filter their new music discovery by following the advocacy and recommendations of not just players with similar tastes, but players who demonstrate credibility as Tastemakers, Influencers, and even Followers.

Important concepts to know:

Each game begins with a “BlackBox” period: At least the first twenty four hours that the game is in play no one can see the results—so anyone is free to add any artist/music without direct influence from the community. After the BlackBox period (24 hours, or more as applicable), the consensus playlist will appear with real-time result tabulation.

Each game ends with a “RedBox” period: up to a full week to ten days before the final consensus playlist is revealed the playlist results will again be hidden: all players will be able to see a playlist of results frozen as of the first day of the Red Box period. Changes to personal playlists during the Red Box period will continue to affect the consensus playlist that is ultimately revealed as the final consensus playlist at the end of the RedBox period.

All players can access and play music on any playlist (consensus playlists, their own personal playlist, and the personal playlist of any other player). Every time you add an artist to your personal playlist you:

(1) must acknowledge an Influencer (another player who already has that artist on their playlist in that game). You will then be offered choices of: the top Influencers for that artist entry; the top influencers with that artist entry whose relevancy (similarity in playlists across the community) to you is highest; people who have influenced you before, who currently have that entry on their personal playlist; people you have designated to “monitor” if they have that entry on their personal playlist in that game. You can also manually “write in” (by screen name) anyone who has that entry on one of their personal playlists.

(2) have the option of writing a few “persuasive” lines about that artist or piece of music, which will then be added to the Bandwagon page (see below) for that artist.

(3) if your playlist is already full (you already have 10 entries) you have to choose which one it will replace. If you remove an artist from your playlist, you lose “continuity” points—you will receive less value for that entry on your playlist than if you had kept that artist on your playlist continuously to the end. (You will still maintain your Influencer value for that artist entry, to the extent others have been influenced by your entry—which will still play into the tabulation of your overall status rating.) However, there are two hidden spaces on each personal playlist where the player can “park” an artist. As long as the artist remains in the player's parking space, they do not figure into the player's status rating (even if that artist appears on the consensus playlist.) Parking an artist in one of those two spaces allows the player to avoid losing “continuity status” for that artist entry—when and if they ultimately return that artist to their playlist. No one other than that player can see those parked entries. If the player later moves one of those parked entries back onto his personal playlist, he does not lose the continuity attached to that entry.

Each individual player maintains a personal playlist for each game. Third party players can access and play entries off any other player's personal playlist, and can also click through to the first party player's “Profile page” (more detail below).

Third party non-players can also access the same off of any player's personal playlist. Non-players can also register their approval of any player's playlist or playlist entries by clicking on the equivalent of a ‘like” button. When there is a large enough statistical sample to reliably demonstrate the rate of adoption of a consensus artist by the community, those “votes of approval” by non-players which correlate with that rate of adoption (thus supporting the spread of influence outside the core player community) may also count in the weighting of particular playlist entries.

Artist badges: if you introduce an artist to the community, and that artist winds up in the top half of the final consensus playlist for that game, as long as you keep that artist on that particular playlist throughout the complete period you play (or in a “parked” space as explained above), you get a “Tastemaker” badge for that artist (you get the badge immediately, but it does not become permanent until after the game is locked). If you are the first person to add that artist you receive the “crowned” Tastemaker badge for that artist. If you are one of the first 25 people to add an artist to a game playlist, and you keep that artist on your playlist throughout the complete period you play, you get an ascending numbered Influencer badge for that artist (you get these badges immediately, but it goes away when the game ends for all but the top five Influencers, who keep an Influencer badge, without the number attached, once the game is locked). Anyone with a current artist badge can add linked content to that artist's Bandwagon page. (Artist badges will be a strong determining factor for you appearing as “relevant” to other players).

Each home page should be able to show up to 5 categories of “soap box” blogs (maybe just the headline and first few lines), which can be expanded:
1) Blog posts by highest ranking players. Blogs from those players Profile page will be carried on the home page of every player (may narrow by genre, so maybe someone who plays mostly hip hop games, gets the blog of the highest ranking player in the hip hop genre; maybe the player can choose which blog they want to appear—by choice of genre).
2) rotating blogs by other players. How often any player's blog shows up on other player's blog page will be a factor of their accrued status in the community.
3) Blog posts by players who have Influenced you,
3) players with most relevancy to you, and
4) players you manually have designated to monitor.
   Activity headlines: changes to playlists, new blog entries and status level achievement by your Influencers, players you are monitoring, players who have most relevancy to you and players you manually have designated to monitor. And a second level of headlines from other players, the frequency of which they show will be a factor of those players’ accrued status in the community.
   Community headlines and blog from the moderator: highlighting what is going on: new games, games coming to an end, new ways to use Bandwagon credits and status.

BANDWAGON Pages:

Should have all the Persuasive comments of players who have added that artist. Each entry should allow reactive comment by other players (not necessary just players who have added that artist). Persuasive Comments should be in order of when the comments were added, beginning with earliest comments but ordered by persons who have the highest credibility ratings overall and within that game; but the player/app user should be able to optionally be sorted in order of most recent comments; in order of players with most relevancy to him; sorted by persons who have influenced him before; sorted by people he has designated to “monitor.”

While a preferred embodiment has been set forth above, those skilled in the art who have reviewed the present disclosure will readily appreciate that other embodiments are possible within the scope of the invention. For example, the invention has applicability beyond music. Also, it can be implemented locally rather than on the Internet. Therefore, the invention should be construed as limited only by the appended claims.

I claim:

1. A computer-implemented method for popularizing items, the method comprising:
(a) providing an electronic community for users;
(b) allowing the users to use the electronic community to add the items to lists;
(c) automatically weighting the users in accordance with timeliness of adding the items to the lists and influence on other users; and
(d) automatically determining popularity of the items in accordance with the weighting and the lists.

2. The method of claim 1, wherein the items are music.

3. The method of claim 2, wherein the items are tracks.

4. The method of claim 2, wherein the items are albums.

5. The method of claim 2, wherein the items are artists.

6. The method of claim 1, wherein:
once one of the items has been introduced to the electronic community, step (b) comprises requiring users wishing to add that item to their lists to identify a user who has influenced them to add that item to their lists; and
step (c) comprises determining each user's influence in accordance with a number of other users who have identified that user in step (b).

7. The method of claim 6, wherein step (c) comprises determining each user's influence also in accordance with times at which the other users have identified that user in step (b).

8. The method of claim 6, further comprising identifying certain ones of the users as tastemakers in accordance with those user's introduction of the items to the community and certain other ones of the users as influencers in accordance with the influence determined in step (c).

9. The method of claim 8, further comprising displaying to the users an identification of the tastemakers and the influencers.

10. The method of claim 6, wherein step (b) is performed in part during a first period in which results are not displayed to the users and in which the users can add the items to their lists without having to identify other users as their influencers.

11. The method of claim 10, wherein step (b) is performed in another part during a second period during which the users wishing to add that item to their lists are required to identify a user who has influenced them to add that item to their lists, and in which only results at a beginning of the second period are displayed to the users, and wherein final results are displayed at an end of the second period.

12. A computer-implemented system for popularizing items, the system comprising:
at least one interface device for communicating with a plurality of users; and
a processor, in communication with the at least one interface device, the processor being configured for:
(a) providing an electronic community for the users;
(b) allowing the users to use the electronic community to add the items to lists;
(c) automatically weighting the users in accordance with timeliness of adding the items to the lists and influence on other users; and
(d) automatically determining popularity of the items in accordance with the weighting and the lists.

13. The system of claim 12, wherein the processor is configured such that the items are music.

14. The system of claim 13, wherein the processor is configured such that the items are tracks.

15. The system of claim 13, wherein the processor is configured such that the items are albums.

16. The system of claim 13, wherein the processor is configured such that the items are artists.

17. The system of claim 12, wherein the processor is configured such that:
once one of the items has been introduced to the electronic community, step (b) comprises requiring users wishing to add that item to their lists to identify a user who has influenced them to add that item to their lists; and
step (c) comprises determining each user's influence in accordance with a number of other users who have identified that user in step (b).

18. The system of claim 17, wherein the processor is configured such that step (c) comprises determining each user's influence also in accordance with times at which the other users have identified that user in step (b).

19. The system of claim 17, wherein the processor is further configured for identifying certain ones of the users as tastemakers in accordance with those users' introduction of the items to the community and certain other ones of the users as influencers in accordance with the influence determined in step (c).

20. The system of claim 19, wherein the processor is further configured for displaying to the users an identification of the tastemakers and the influencers.

21. The system of claim 17, wherein the processor is configured such that step (b) is performed in part during a first period in which results are not displayed to the users and in which the users can add the items to their lists without having to identify other users as their influencers.

22. The system of claim 21, wherein the processor is further configured such that step (b) is performed in another part during a second period during which the users wishing to add that item to their lists are required to identify a user who has influenced them to add that item to their lists, and in which only results at a beginning of the second period are displayed to the users, and wherein final results are displayed at an end of the second period.
